(19) United States
(12) Patent Application Publication
(10) Pub. No.: US 2013/0265639 A1
(43) Pub. Date: Oct. 10, 2013

(54) Accurate Telescope Tracking System with a Calibrated Rotary Encoder

(71) Applicant: Andrey Borissov BATCHVAROV, Redmond, WA (US)

(72) Inventor: Andrey Borissov BATCHVAROV, Redmond, WA (US)

(21) Appl. No.: 13/859,697

(22) Filed: Apr. 9, 2013

Related U.S. Application Data
(60) Provisional application No. 61/621,848, filed on Apr. 9, 2012.

(51) Int. Cl. G02B 23/16

(52) U.S. Cl. CPC G02B 23/165; G02B 23/16
USPC 359/430; 359/429

(57) ABSTRACT

A system with a calibrated rotary encoder can be used for accurate telescope tracking along the Right Ascension (RA) rotation axis. The system includes an incremental quadrature optical encoder, a microcontroller unit (MCU), a timer, an electronic memory, and a control interface. The rotor of the encoder is coaxially attached to the RA drive shaft of the telescope mount in order to send angular position data for the RA drive shaft to the MCU. The MCU evaluates the angular position data for errors and send corrections to the control mechanism of the RA drive shaft. The electronic memory stores calibrated reference data, which is compared to the angular position data by the MCU. The calibrated reference data can be found by measuring the movement of a reference star across an image. The system can also calculate an accurate visible speed for the Earth's rotation in a desired direction.

The current application claims a priority to the U.S. Provisional Patent application Ser. No. 61/621,848 filed on Apr. 9, 2012.

### FIELD OF THE INVENTION

The present invention relates generally to a system for correcting the angular rotations of an astronomical telescope along Right Ascension axis by utilizing a calibrated incremental pulse rotary encoder attached in coaxial manner with the shaft of right ascension drive system of the telescope mount. Moreover, the present invention also relates to a method for calibrating and testing the rotary encoder by tracking a reference star while telescope drive system rotates along the Right Ascension axis with close to sidereal speed of rotation.

### BACKGROUND OF THE INVENTION

Astronomical telescopes are used for acquiring images of celestial objects with low light such as distant stars, galaxies, and so on. Normally this requires long exposure during which the object is kept in same place on the registering device, latter being photographic plate or digital camera. To achieve this, the telescope drive system must ensure accurate rotation of the telescope along an axis (Right Ascension axis) parallel to the axis of the Earth's rotation and with rotational speed equal to that of the Earth, the latter is about one revolution in 23 hours and 56 minutes. This setup is known as Equatorial Setup. Procedure of aligning the axis of rotation of the telescope to be parallel to the axis of rotation of The Earth is known as Polar Alignment. The commonly desired accuracy must be such that the accumulated error for a period of 5 or more minute long exposure is less than 1 to 2 angular seconds (arc second). Widely a mean to achieve this is by using worm gear in the drive system that rotates the telescope along the Right Ascension (RA). However, small variations of the surface of the worm, even within microns, may result in inaccurate tracking of the celestial object during the exposure. Common technique to correct for these variations is using a second telescope, denoted as a guiding telescope, attached to the imaging telescope and using image of a reference star registered via the guiding telescope to evaluate deviations from the desired rotation. Another existing technique is to use angular velocity encoder attached to the RA (Right Ascension) rotational part of the telescope and use it as feedback for actual speed of rotation. Such an approach is disclosed in patent WO 2009/077799, which describes a system where angular velocity encoder is attached to telescope drive system and angle of rotation is obtained by means of interpolation and integration. Next, if angle of rotation is not as required the system sends correction commands to the telescope mount to correct the rotation. Such approach however requires high accuracy velocity encoder since a small error of the measured velocity will result in accumulation of significant positional error over time. The longer is the exposure and integration time the bigger will be the accumulated error. The Earth's rotational speed is about 15 arc seconds per a time second. Hence, in order that the accumulated error is within 3 arc seconds for 100 seconds long exposure, the encoder must measure the rotational speed with accuracy of 99.8% or better. In addition, if the actual rotational speed of the telescope is not constant, which is the case with real telescope drive system, integration over time is needed in order to know the total rotation. The accuracy of the integration will depend on the frequency the velocity is measured with and the accuracy of the measurement.

### SUMMARY OF THE INVENTION

The present invention utilizes an incremental quadrature optical encoder with measuring relative rotation to the initial orientation at the start of imaging using the pulses generated by the encoder. Provided that the encoder pulses are exactly equally spaced in rotation units, the actual rotation can be calculated from the pulse count. If this rotation is different from the expected one, then a correction signal can be sent to the telescope RA drive system. Frequency at which the correction needs to be made depends on the quality of the particular telescope RA drive system and for widely used amateur telescopes is between 1 and 4 seconds. Since one rotation of the Earth is about 86,000 seconds, an encoder with at least 20,000 counts per revolution (CPR) must be used. Any inaccuracy of the actual position of pulses from the encoder will result in wrong corrections and inaccurate tracking of the object being imaged. Higher accuracy demands more advanced technology used in manufacturing of the encoder and hence more expensive encoder. The present invention described here provides an alternative solution by using less accurate and less expensive encoder for which actual positions of the pulses are measured accurately during calibration procedure and stored on an electronic memory. Such a system combining a rotary encoder with stored calibration data is known as a calibrated rotary encoder. During the operation, the actual position for each pulse generated is retrieved from a memory, part of the system, and used by a MCU microcontroller unit (MCU) to calculate the proper correction signals to be sent to the RA drive system of the telescope. The present invention requires calibration of each particular instance of the device manufactured. The present invention also relies on the high level of repeatability of generated pulses with respect to the rotation which is true for most of optical encoders.

### BRIEF DESCRIPTION OF THE DRAWINGS

FIG. 1 is a diagram illustrating the system for the present invention.

FIG. 2 is a diagram illustrating the pulse signals from an incremental quadrature encoder, wherein the incremental quadrature encoder produces two phase-shifted pulse-trains and an index pulse that can be used to interpret the angular position of the encoder rotor.

FIG. 3 is a table illustrating the calibration reference data for each of the reference tracking pulses.

FIG. 4 is a flow chart that describes the overall process for utilizing the system of the present invention.

FIG. 5 is a flow chart that describes the specific process of evaluating the rotation of the RA drive shaft by generating a series of tracking pulses.

FIG. 6 is a flow chart that describes the specific process of correcting errors in the rotation of the RA drive shaft by finding the difference between the actual and the expected change in angular position.

FIG. 7 is a flow chart that describes the specific process of correcting errors in the rotation of the RA drive shaft by synchronizing each subsequent tracking pulse with their expected occurrence time.

FIG. 8 is a flow chart that describes the overall process of calibrating the system of the present invention.

FIG. 9 is a continuation of the flow chart shown in FIG. 8.

FIG. 10 is a flow chart that describes the specific process of determining the speed of a reference star across a series of images while the telescope does not rotate.

FIG. 11 is a flow chart that describes the specific process of determining the linear positional deviation of the reference star across another series of images while the telescope does rotate.

FIG. 12 is a flow chart that describes the specific process of deriving an angular correction for each reference tracking pulse within the calibrated reference data.

FIG. 13 is a flow chart that describes the initialization process of determining the visible speed of the Earth's rotation in a desired direction.

FIG. 14 is a flow chart that describes the calculation process of determining the visible speed of the Earth's rotation in a desired direction.

FIG. 15 is a flow chart that describes the specific process of building a mathematical model in order to describe the Earth's atmospheric refraction.

### DETAIL DESCRIPTIONS OF THE INVENTION

All illustrations of the drawings are for the purpose of describing selected versions of the present invention and are not intended to limit the scope of the present invention.

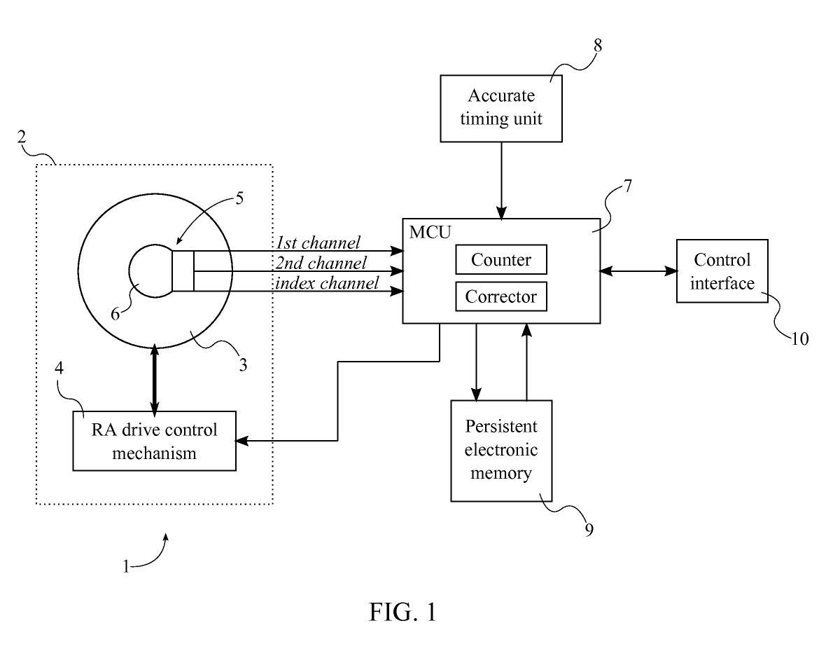

The present invention is a system and a method to improve the Right-Ascension-rotation accuracy for a telescope. As can be seen in FIG. 1, the system mainly comprises a telescope mount 1, an incremental quadrature optical (IQO) encoder 5, a microcontroller unit (MCU) 7, an accurate timing unit 8, a persistent electronic memory 9, and a control interface 10. The telescope mount 1 is the means to support and rotate a telescope and comprises a Right Accession (RA) drive system 2, which allows the telescope to rotate in the Right Accession arc. The RA drive system 2 comprises an RA drive shaft 3 and an RA drive control mechanism 4. The telescope mount 1 rotates about the RA drive shaft 3, and the RA drive control mechanism 4 manages the rotation of the RA drive shaft 3. The IQO encoder 5 is used to determine the angular position of the RA drive shaft 3. The IQO encoder 5 comprises an encoder rotor 6 that can uniformly rotate with the RA drive shaft 3. Thus, the encoder rotor 6 is coaxially and mechanically attached to the RA drive shaft 3. The MCU 7 is used to manage data flow and commands between components of the system. The IQO encoder 5 is electronically connected to the MCU 7, which allows the IQO encoder 5 to send two pulse channels and an indexing pulse to the MCU 7. The two pulse channels include information that describes the angular position and the rotation direction of the RA drive shaft 3. The index pulse signals one full revolution of the encoder rotor 6 and is used as a reference for each pulse from the two pulse channels. The accurate timing unit 8 is electronically connected to the MCU 7, which allows the MCU 7 to clock each pulse from the two pulse channels. The persistent electronic memory 9 is electronically connected to the MCU 7, which allows the system to save information once the power supply for the system is turned off. The control interface 10 is electronically connected the MCU 7, which allows an operator to interact with the system. The control interface 10 provides at least the following commands: powering the system on and off, indicating the detection of the index pulse, displaying the information received by the IQO encoder 5, and setting the desired speed of rotation for the RA drive shaft 3. The MCU 7 is also used to perform calculations and generate commands in order to correct the rotation of the RA drive shaft 3. Thus, the MCU 7 is electronically connected to the RA drive control mechanism 4 so that commands can be sent to the RA drive control mechanism 4 such as tracking corrections. Tracking corrections can also be sent to an external control system for the RA drive shaft 3 through the control interface 10. The RA drive control mechanism 4 is operatively coupled to RA drive shaft 3 so that the RA drive control mechanism 4 can adjust the rotation of the RA drive shaft 3.

The IQO encoder 5 transmits two pulse channels that describe the rotation direction and the angular position of the RA drive shaft 3. Consequently, the encoder rotor 6 comprises a coded track and an index mark. The coded track is concentrically positioned around the encoder rotor 6 so that the coded track is able to represent every angular position around the encoder rotor 6. Thus, the two pulse channels are read off the coded track as the RA drive shaft 3 is rotated. The rising/falling edges from the two pulse channels is able to convey the angular position of the RA drive shaft 3, and the order of the rising/falling edges from each pulse channel is able to convey the rotation direction of the RA drive shaft 3. The index mark is positioned at one point around the coded track so that the index mark is able to represent a single angular position around the encoder rotor 6. Thus, the index pulse is read off the index mark when the RA drive shaft 3 makes one full revolution.

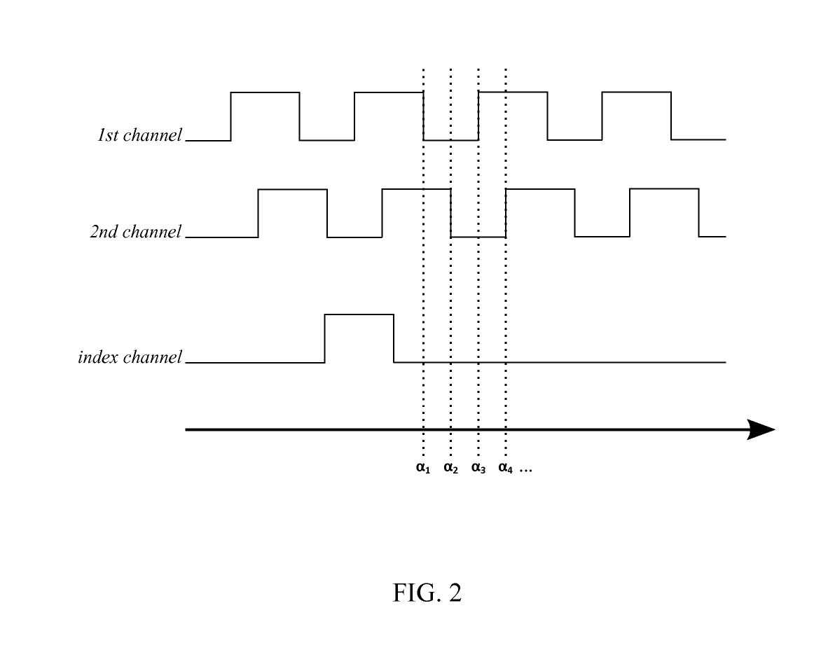

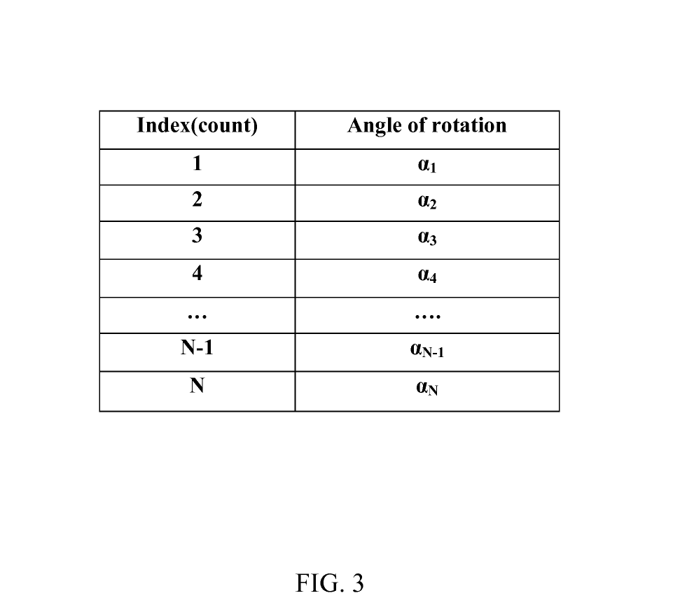

FIG. 2 shows typical ordering of pulses from the first pulse channel and the second pulse channel and shows the index pulse from a third pulse channel generated by a typical quadrature optical encoder. An index pulse is generated on a third pulse channel once per revolution of the encoder rotor 6 indicating exactly 360 degrees of rotation. Again, the direction of rotation is defined by the order at which rising or falling edges occurs on the first pulse channel and the second pulse channel. For example, the positive direction of rotation is indicated by the rising edge from the first pulse channel preceding the rising edge from the second pulse channel, and the opposite direction of rotation is indicated by the rising edge from of the second pulse channel preceding the rising edge from the first pulse channel. As can be seen in FIG. 3, the persistent electronic memory 9 stores the calibrated reference data for each reference tracking pulse, which includes the actual angle of rotation relative to the index pulse.

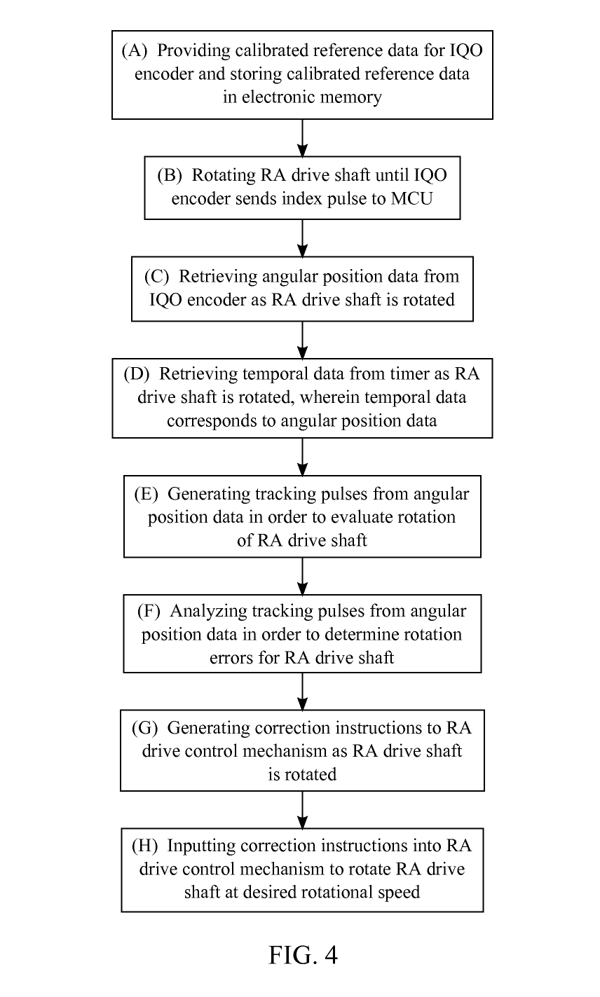

As can be seen in FIG. 4, the method of implementing the system describes how the system components are able to evaluate and correct the rotation of the RA drive shaft 3 so that the RA drive shaft 3 is able to rotate at the desired rotational speed. In general, the MCU 7 retrieves angular position data from the IQO encoder 5 as the RA drive control mechanism 4 rotates the RA drive shaft 3. The MCU 7 also retrieves temporal data from the accurate timing unit 8 as the RA drive control mechanism 4 rotates the RA drive shaft 3, wherein the temporal data corresponds to the angular position data. The MCU 7 generates a series of tracking pulses from the angular position data in order to evaluate the rotation of the RA drive shaft 3. The MCU 7 can then analyze the series of tracking pulses in order to determine tracking errors that prevent the RA drive shaft 3 from rotating at a desired rotational speed. The MCU 7 will rectify those tracking errors by generating correction instructions to adjust the rotation of the RA drive shaft 3. The corrections instructions are then inputted into the RA drive system 2 so that the RA drive control mechanism 4 rotates the RA drive shaft 3 at the desired rotational speed.

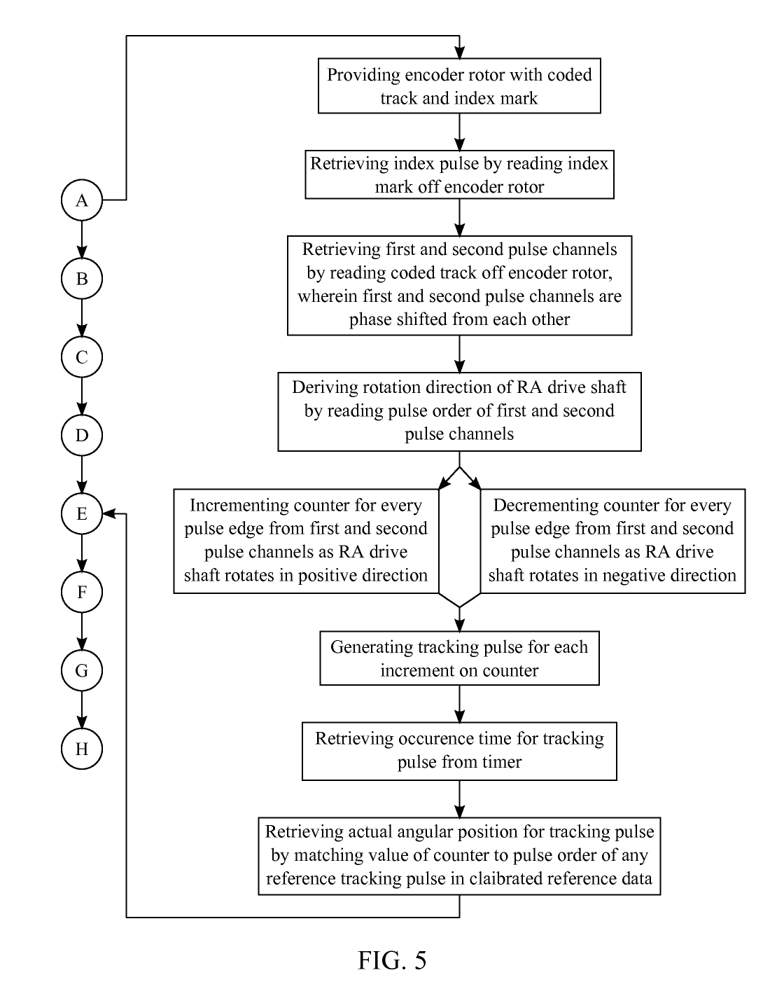

More specifically, the system is first initialized by rotating the RA drive shaft 3 with the RA drive control mechanism 4 until the index pulse is detected by the MCU 7, which is shown in FIG. 5. The MCU 7 uses an internal pulse counter to uniquely identify each pulse received from the IQO encoder 5. The internal pulse counter is set to zero upon receiving an index pulse from the encoder. The MCU 7 next receives all pulses sent by the IQO encoder 5 from both pulse channels as a result of rotation of the RA drive shaft 3. The MCU 7 uses the information from both pulse channels to determine the direction of rotation for the RA drive shaft 3. On every rising/falling edge of a pulse received from any of the two pulse channels, the MCU 7 increments the internal pulse counter if the RA drive shaft 3 rotates in a positive direction and decrements the internal pulse counter if the RA drive shaft 3 rotates in a negative direction. The rotation direction is chosen positive if it is same as the Earth's rotation and is chosen negative if it is opposite the Earth's rotation. Every time that the internal pulse counter is incremented, a tracking pulse is generated by the MCU 7. For each tracking pulse, the MCU 7 retrieves an occurrence time from the accurate timing unit 8 and retrieves an actual angular position from the calibrated reference data found on the persistent electronic memory 9. The index that is used to search through the calibrated reference data is the value of the internal pulse counter.

When imaging (tracking) session starts, the MCU 7 logic waits for the initial tracking pulse. For this initial tracking pulse, the occurrence time T₀ is obtained from the accurate timing unit 8, and the actual angular position α₀ from the persistent electronic memory 9. For every consecutive tracking pulse, the system retrieves the actual angular position α from the persistent electronic memory 9, and the occurrence time T from the accurate timing unit 8. Next, the MCU 7 calculates the expected change in angular position for the time interval (T−T0) using the preset desired rotational speed Ω:

Δαₑ=Ω*(T−T₀)

and the actual change in angular position is:

Δα=(α−α₀).

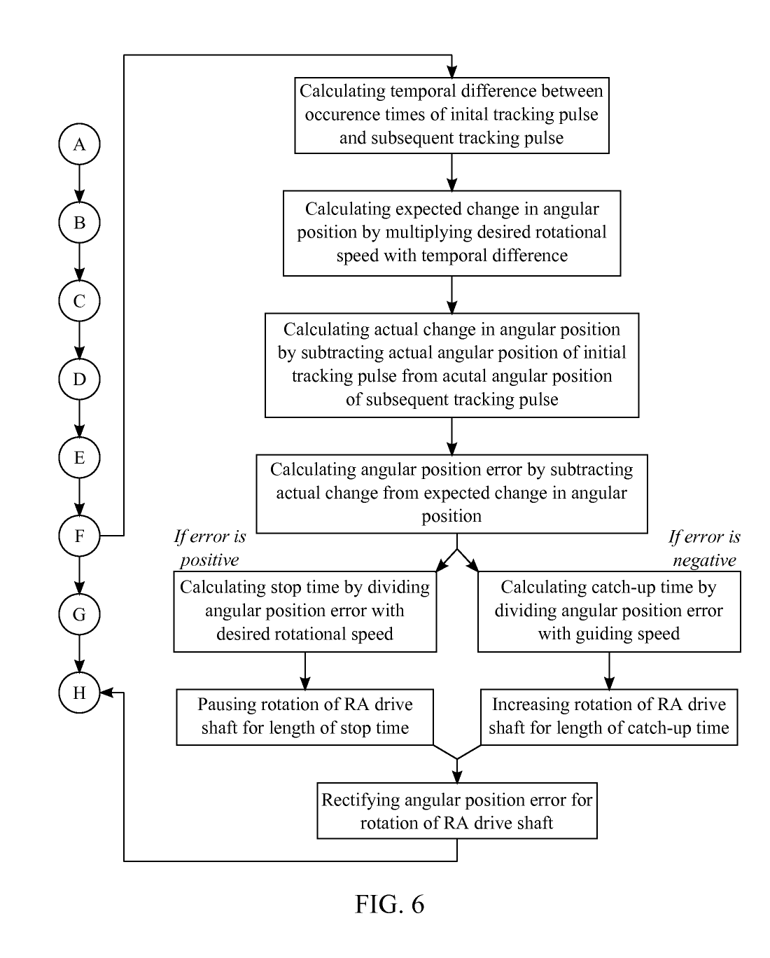

As can be seen in FIG. 6, the difference between Δαₑ and Δα defines the tracking error of the RA drive system 2 at moment of time T:

E(T)=(Δαₑ−Δα)

This tracking error is then used to send corrections commands to the RA drive control mechanism 4. If the tracking error is towards the East meaning the telescope has rotated slower than needed, then a correction command is sent to the RA drive control mechanism 4 to set the RA drive shaft 3 at a guiding speed ω_{g}, which is greater than the sidereal speed of rotation (usually about 2 times higher) for a catch-up time period:

Δt=E(T)/ω_{g}

If the tracking error is towards the West meaning the telescope has rotated faster than needed, then a correction command is sent to the RA drive control mechanism 4 to stop the rotation of the RA drive shaft 3 for a stop time period:

Δt=E(T)/Ω

The tracking error can also be defined in a positive/negative direction in terms of the Earth's rotation. The tracking error in the positive direction is defined as with the Earth's rotation. The tracking error in the negative direction is defined as against the Earth's rotation.

Close to the celestial meridian or the zenith, the desired rotational speed Ω would be the sidereal speed of the Earth's rotation, which to a good approximation is one revolution in 23 hours and 56 minutes. However, farther the celestial meridian or the zenith, the visible rotation of the celestial sky is affected by refraction caused by the Earth's atmosphere. In order to compensate for the atmospheric refraction, the desired rotational speed can be set through the control interface 10 by a person operating the telescope or automatically from an external control system.

The value of the internal pulse counter can be stored into the persistent electronic memory 9 so that the value is preserved even when the system is powered off. In the preferred embodiment, the persistent electronic memory 9 is an electrically erasable programmable read-only memory (EEPROM). Thus, upon powering on the system, the system will not need to find index pulse again and can continue to normally operate. However, if the RA drive shaft 3 is rotated while the system is powered off, then the value for the internal pulse counter will not be relevant, and the RA drive shaft 3 will need to be rotated in order to find the index pulse again.

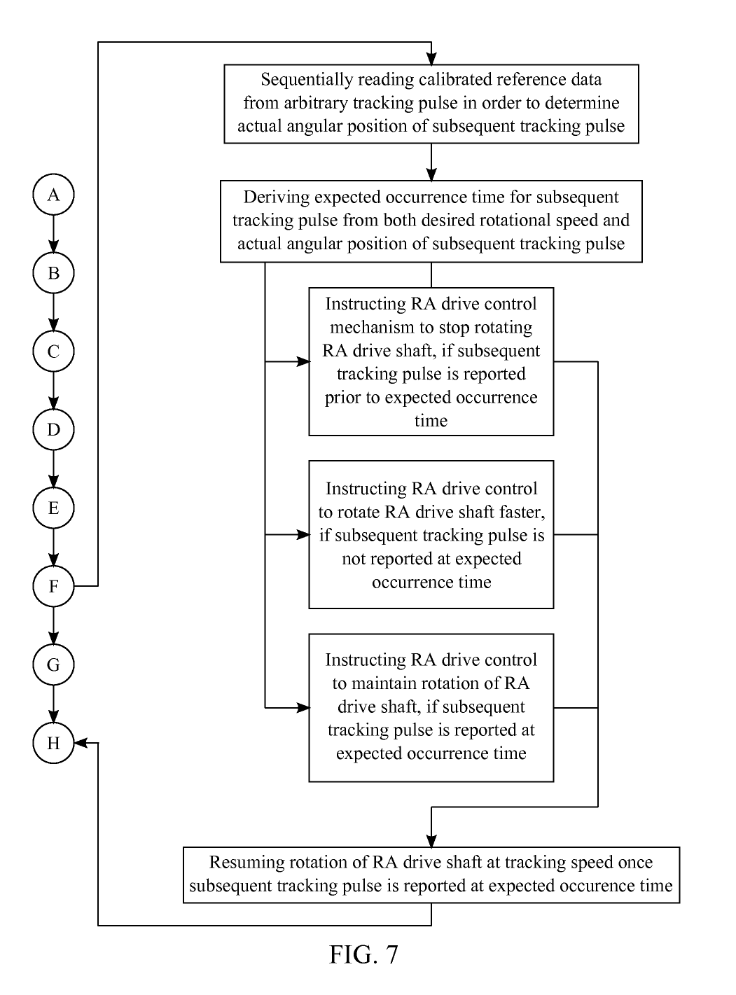

In reference to FIG. 7, an alternative method of correcting the rotation of the RA drive shaft 3 is by synchronizing each tracking pulse with its expected occurrence time. Every arbitrary tracking pulse will have a subsequent tracking pulse with an expected occurrence time. More specifically, this alternative method synchronizes the actual occurrence time with the expected occurrence time of the subsequent tracking pulse. This alternative method includes the following steps: Once an arbitrary tracking pulse is generated by the MCU 7, the angular position for the subsequent tracking pulse is determined by sequentially reading through the calibrated reference data from the arbitrary tracking pulse. Next, the expected occurrence time tₑ of the subsequent tracking pulse is derived from both its angular position and the desired rotational speed of the RA drive shaft 3. The accurate timing unit 8 is instructed to report the actual occurrence time t of the subsequent tracking pulse. If the subsequent tracking pulse is received at time t prior to the expected occurrence time −tₑ, then the RA drive shaft 3 has rotated faster than the desired rotational speed. Correction instructions are generated and sent to the RA drive control mechanism 4 to stop the rotation of the RA drive shaft 3 and to resume the rotation of the RA drive shaft 3 when the accurate timing unit 8 reports the expected occurrence time of the subsequent tracking pulse. Consequently, the Earth's rotation will rectify the rotation of the RA drive shaft 3 because the Earth's rotation is constant and independent of the RA drive system 2 and its mechanical quality. If the subsequent tracking pulse is not received at the expected occurrence time, then the RA drive shaft 3 has rotated slower than the desired rotational speed. Correction instructions are generated to rotate the RA drive system 2 at a faster speed than the desired rotational speed (ω_{correction}>Ω) until the subsequent tracking pulse is reported by the accurate timing unit 8. Finally, if the subsequent tracking pulse is received at the expected occurrence time, then the RA drive control mechanism 4 is instructed to maintain the current rotation of the RA drive shaft 3. With this approach, the rotation is corrected by means of synchronizing with the tracking pulses, which are received by the MCU 7 with practically with no delay. Thus, this approach is more independent of the mechanical quality and linear response of the RA drive system 2.

Vibrations during operation can result in wrong counting of pulses. For instance, if small rotational vibrations occur when the rotation is close to a pulse edge may result in series of short internal pulses. The source of such vibrations can be a wind gust acting on the telescope tube, mechanical imperfections in the RA drive system 2, a person walking near the telescope, etc. To ensure that such vibrations will not result in wrong indexing of pulses, the MCU 7 should operate at a high enough frequency in order to detect every pulse edge from the first pulse channel and the second pulse channel and to keep accurate pulse indexing. For instance, such vibrations occurring near the rising edge of a pulse from the first pulse channel can result in numerous rising and falling edge detections in a short period of time. This may also result in the MCU 7 generating multiple tracking pulses in short period of time. In order to avoid issuing multiple calculations and corrections for the rotation in short period of time, the MCU 7 logic must wait for some predefined interval of time after each tracking pulse is generated before generating a new tracking pulse. Reliability of such an approach is based on the fact that the average distance between tracking pulses is known and variations of pulses position is small. In addition, the rotational speed is nearly constant with small variations and is known to be close to the sidereal speed of the Earth's rotation. If the average time between tracking pulses during sidereal speed of the Earth's rotation is <Tp> with maximum deviation −Te, then the interval of time during which the MCU 7 will wait before allowing a new tracking pulse to be generated and can be chosen to be <Tp>−Te. A more general condition is to choose that time interval to be <Tp>/2 as in practically produced telescopes the variation of sidereal rotation of RA due to imperfection of the system is much less than 50%. The alternative approach is to allow the MCU 7 to generate a new tracking pulse only if time period between two encoder pulses in quadrature configuration is greater than <Tp>−Te. In this case, spurious rotations caused by wind gusts even of magnitude of vibration is several pulses will be disregarded. Further if no tracking pulses are generated for some predefined time, then the system will stop monitoring the rotation of the RA drive shaft 3 and will send a correction signal to the RA drive control mechanism 4. Alternatively, if tracking pulses are generated, then the system will restart with new initial values T₀ and α₀ and will begin monitoring and correcting the rotation of the RA drive shaft 3 with respect to the new initial values.

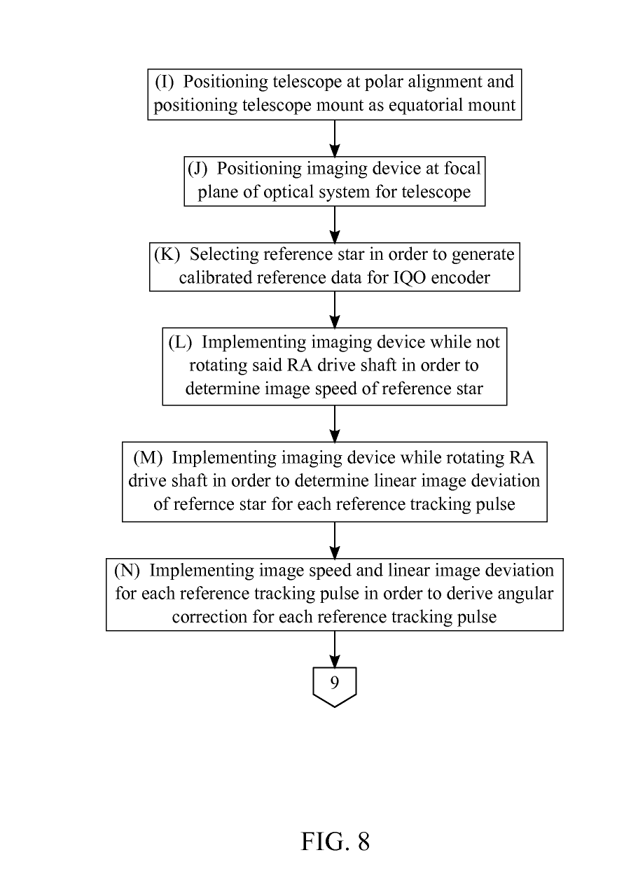

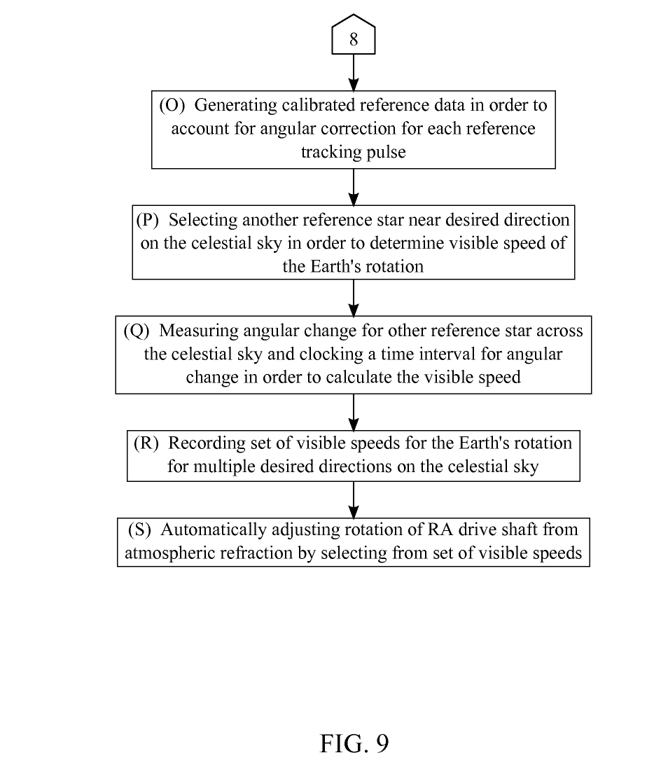

As can be seen in FIGS. 8 and 9, the method of calibrating the system describes how to best adjust the component of the system in order accurately evaluate the rotation of the RA drive shaft 3. In order to accomplish this calibration method, the telescope further comprises an optical system and an imaging device. The optical system allows the telescope to magnify the image of a celestial object and the imaging device is used to capture the image of a celestial object. Thus, the imaging device is positioned at the focal plane of the optical system. The telescope is also positioned at a polar alignment, which occurs when a rotation axis for the telescope mount 1 is parallel to the Earth's rotation axis. The telescope mount 1 is positioned to be an equatorial mount. In general, the calibrated reference data for the IQO encoder 5 can be derived from a reference star. The imaging device is used to determine the image speed of a reference star while not rotating the RA drive shaft 3. The imaging device is then used to determine the linear deviation of the reference star for each reference tracking pulse within the calibrated reference data. Finally, the MCU 7 derives an angular correction for each reference tracking pulse by implementing the image speed and its linear deviation. Also in general, the visible speed of the Earth's rotation can be derived from another reference star near the desired direction on the celestial sky. An angular change for this reference star across the celestial sky is measured and a time interval for the angular change is clocked in order to calculate the visible speed. Also in general, a set of visible speeds of the Earth's rotation can be recorded for multiple desired directions on the celestial sky, which allows the system to automatically adjust the rotation of the RA drive shaft 3 to account for the atmospheric refraction.

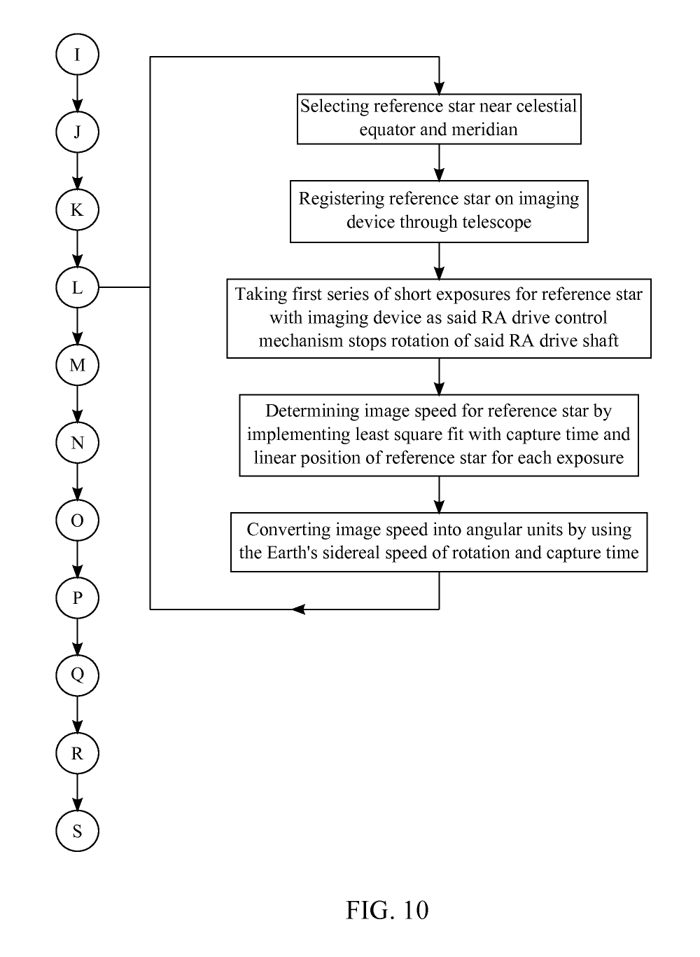

More specifically, the calibration of the IQO encoder 5 can be made by means of tracking a reference star while the telescope mount 1 is rotated along RA axis at Earth's sidereal speed of rotation, which is shown in FIG. 10. A reference star is selected near the celestial equator and meridian. The reference star needs to register on the imaging device, and, thus, the reference star should be also bright enough so that short exposures of one second duration or less can be used to reliably measure the reference star's position on the imaging area. A first series of short exposures are taken by the imaging device at equal intervals while the telescope RA drive system 2 is stopped. While the RA drive system 2 is stopped, the linear position of the reference star moves on the image area as a result of the Earth's rotation. The capture time Tₖ is measured for each exposure, and the linear position Xₖ of the reference star is measured along the line of its movement on the image surface. The image speed Vₛ is the speed that the reference star moves across the image surface and is calculated from a least square fit of the recorded values {Tₖ, Xₖ} with the linear function:

X=Vₛ*(Tₖ−T₀)+X₀.

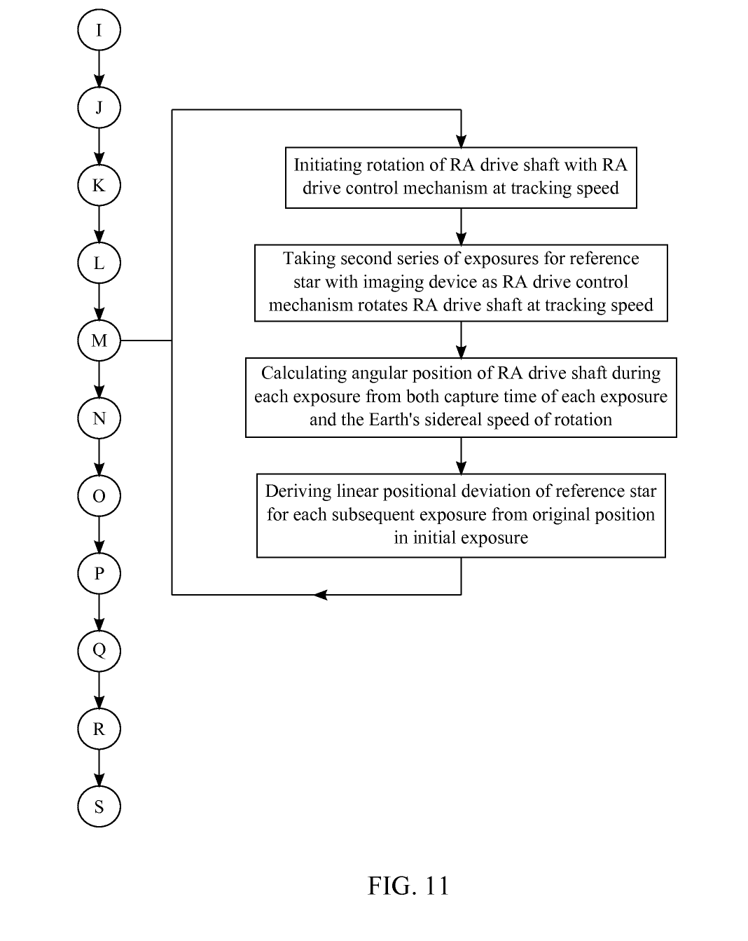

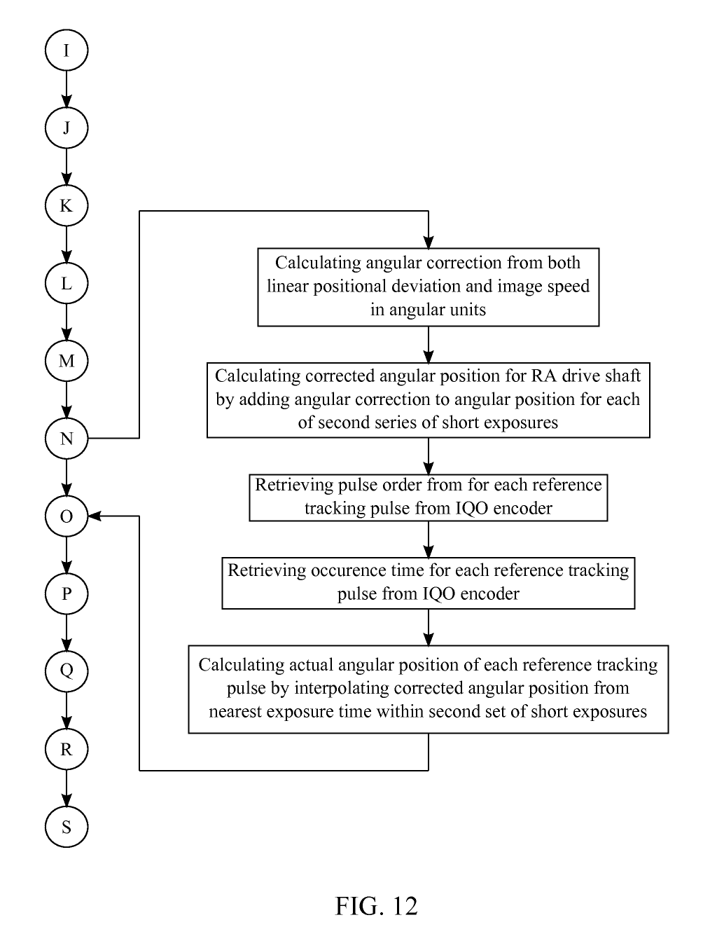

The image speed is then converted into angular units by using the Earth's sidereal speed of rotation and the capture time. Next, the RA drive system 2 is turned on so that the telescope rotates about the RA drive shaft 3 at a tracking speed and follows the reference star as a second series of short exposures are taken by the imaging device, which is shown in FIG. 11. The tracking speed is expected to be equal to the Earth's sidereal speed of rotation. If RA drive system 2 of the telescope is ideal, then the position of the reference star on the image area should remain the same. Because of the imperfections within the RA drive system 2, the position of the reference star on the i^{th} frame taken at a capture time T will be: S₀+ΔSᵢ, where S₀ is the linear position of the reference star on the initial exposure and ΔSᵢ is the linear deviation from S₀ for each subsequent exposure. As can be seen in FIG. 12, a corrected angular position of the RA drive shaft 3 from the initial position at time Tᵢ is:

(αᵢ−α₀)=(Tᵢ−T₀)*Vᵣ+(ΔSᵢ/Vₛ)*Vᵣ

where Vᵣ is the speed of sidereal rotation in angular units per second, wherein (ΔSᵢ/Vₛ)*Vᵣ is known as the angular correction. Simultaneously, tracking pulses are received from the IQO encoder 5 and are recorded with their pulse order k and their occurrence time −T^{p}ₖ, which is retrieved from the accurate timing unit 8. The actual angular position for each reference tracking pulse—α^{p}ₖ at time T^{p}ₖ is calculated by interpolation the subset of {αᵢ, Tᵢ} at time T^{p}ₖ. To ensure reliable interpolation, the second series of short exposures should be taken at a time interval that is close to the time interval between tracking pulses generated from the IQO encoder 5 while RA drive shaft 3 rotates at the tracking speed. In order to calibrate the entire IQO encoder 5, a full rotation of 360 degree is needed, which requires the calibration to be completed over several observing nights using several reference stars. These reference stars are selected with such RA coordinates so that the full rotation is covered. After all reference tracking pulses from the IQO encoder 5 are calibrated, the system re-indexes the reference tracking pulses and recalculates their angular positions with respect to the index pulse of the IQO encoder 5. If calibration is performed for part of the IQO encoder 5, then the encoder rotor 6 must be attached to the RA drive system 2 in such an orientation with respect to the RA drive shaft 3 so that the index pulse of the IQO encoder 5 is within the span of the calibrated rotation.

The accuracy of telescope rotation achieved using the described system depends on the accuracy of calibrated reference data for the IQO encoder 5, the repeatability of the angular position for the tracking pulses, and the mechanical quality of the IQO encoder 5, and the coaxial attachment between the encoder rotor 6 and the RA drive shaft 3. In reality, it is impossible to achieve an ideal coaxial attachment between the encoder rotor 6 and the RA drive shaft 3. A small coaxial misalignment between the encoder rotor 6 and the RA drive shaft 3 will result in a difference between the angular position that is reported by the IQO encoder 5 and actual rotation of the RA drive shaft 3. However, this error will vary little with the angular position and within a relatively small span of rotation, comparable to the one during single photographic exposure, the speed of rotation will be constant enough to be used for accurate correction of the telescope rotation. This speed however may be different from the actual desired rotational speed. The actual required rotational speed can be expressed as eq. (1):

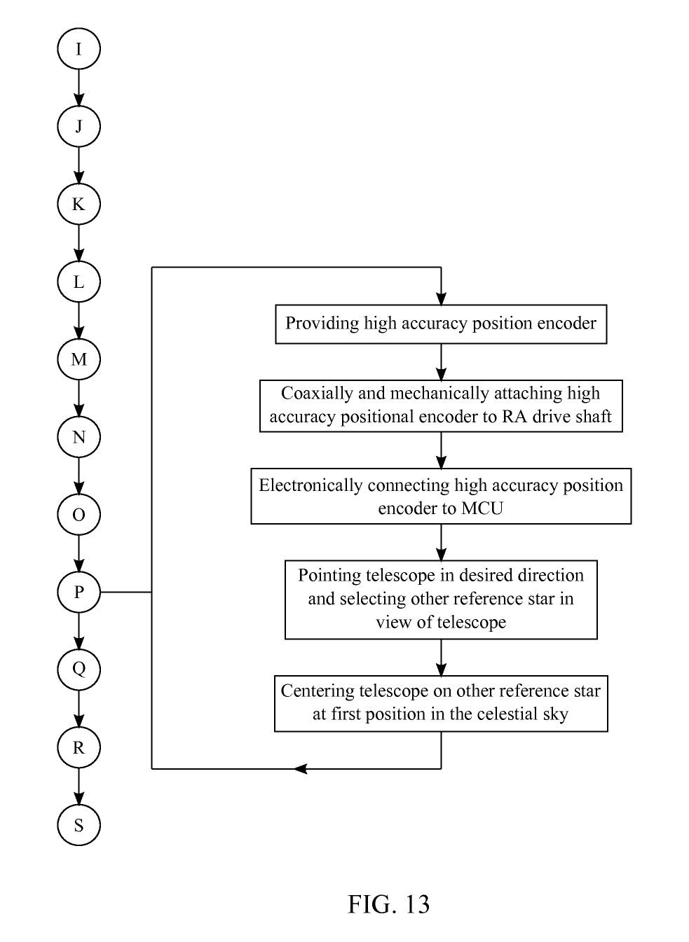

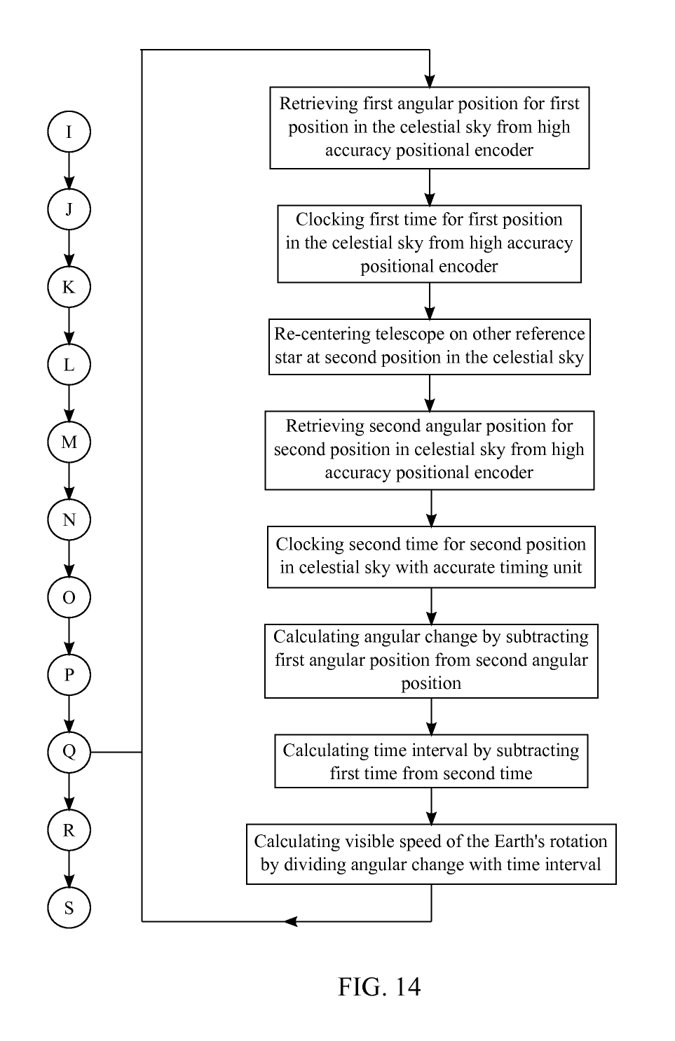

Ω′=k*Ω

where k is a correction coefficient. As can be seen in FIGS. 13, and 14, the correction coefficient can be found by tracking another reference star at a desired direction, which is close to the object to be imaged on the celestial sphere. First, the telescope is pointed toward that desired direction and a nearby bright star is centered at the crosshair of a guiding eyepiece or an imaging device. At this moment, the IQO encoder 5 and the accurate timing unit 8 is initialized to record initial angular position −α₀ and an initial time t₀. At the end of calibration session with duration t (selected close to desired exposure time), the reference star is again centered using correction controls of the telescope, and the IQO encoder 5 is set to measure Δα. The actual speed of rotation Ω′ can be expressed as eq. (2):

Ω′=[(αᵢ−α₀)/(tᵢ−t₀)]

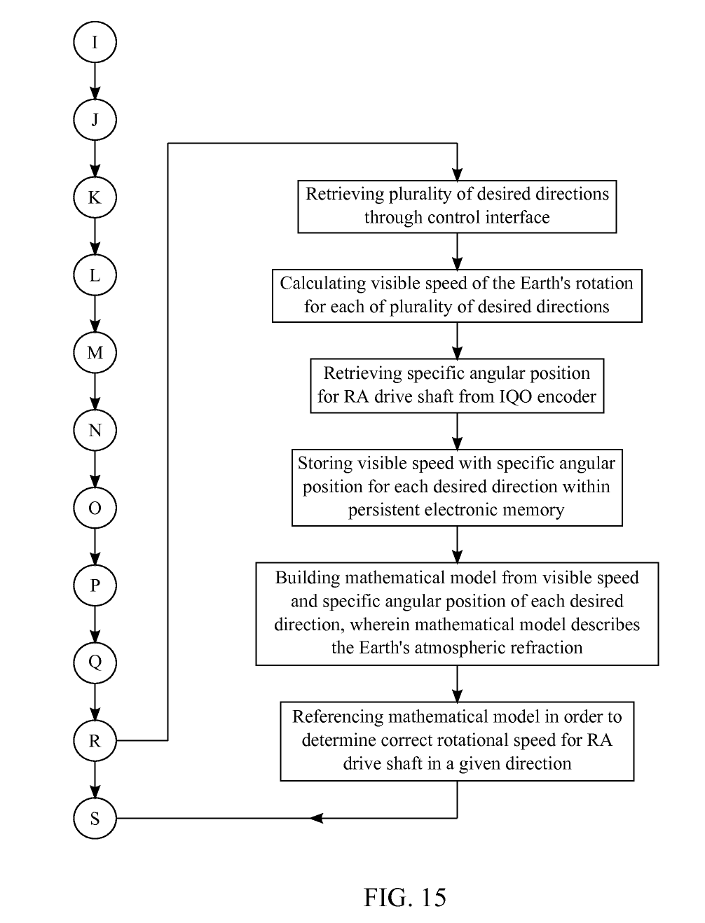

The actual speed of rotation SY is calculated from eq. (2), and the correction coefficient k is calculated from eq. (1) for that desired direction on the celestial sphere. If this desired direction is at or close to the celestial meridian, the RA drive shaft 3 will correctly rotate at the actual sidereal speed of the Earth's rotation. By providing the correction coefficient for different desired directions on the celestial sphere (for example, the meridian and close to east and horizon), a mathematical model for any mechanical misalignment between encoder rotor 6 and the RA drive shaft 3 and for atmospheric refraction can be built for the operation location of the telescope and can be used to predict the proper correction of the rotational speed in any desired direction on the celestial sphere, which is shown in FIG. 15. This requires the desired direction of the telescope to be provided either automatically through the control interface 10 or the external system controlling the telescope orientation.

Although the invention has been explained in relation to its preferred embodiment, it is to be understood that many other possible modifications and variations can be made without departing from the spirit and scope of the invention as hereinafter claimed.

What is claimed is:

1. A system to improve Right-Ascension-rotation accuracy of a telescope comprises:
a telescope mount;
an incremental quadrature optical (IQO) encoder;
a microcontroller unit (MCU);
an accurate timing unit;
a persistent electronic memory;
a control interface;
said telescope mount comprises a Right Accession (RA) drive system;
said IQO encoder comprises an encoder rotor;
said RA drive system comprises an RA drive shaft and an RA drive control mechanism;
said encoder rotor being coaxially and mechanically attached to said RA drive shaft;
said IQO encoder being electronically connected to said MCU;
said accurate timing unit being electronically connected to said MCU;
said control interface being electronically connected to said MCU;
said MCU being electronically connected to said RA drive control mechanism; and
said RA drive control mechanism being operatively coupled to said RA drive shaft.

2. The system to improve Right-Ascension-rotation accuracy of a telescope as claimed in claim 1 comprises:
said encoder rotor comprises a coded track and an index mark;
said coded track being concentrically positioned around said encoder rotor; and
said index mark being positioned at one angular point around said coded track.

3. A method of implementing a system to improve Right-Ascension-rotation accuracy for a telescope, the method comprises the steps of:
providing a telescope mount, an incremental quadrature optical (IQO) encoder, a microcontroller unit (MCU), an accurate timing unit, a persistent electronic memory, and a control interface;
wherein said telescope mount comprises a Right Accession (RA) drive system;
wherein said IQO encoder comprises an encoder rotor;
wherein said RA drive system comprises an RA drive shaft and an RA drive control mechanism;
wherein said encoder rotor comprises a coded track and an index mark;
providing said calibrated reference data for said IQO encoder and storing said calibrated reference data on said persistent electronic memory, wherein said calibrated reference data includes a pulse order and an actual angular position for each reference tracking pulse;
rotating said RA drive shaft until said IQO encoder sends an index pulse to said MCU;
retrieving angular position data from said IQO encoder as said RA drive control mechanism rotates said RA drive shaft;
retrieving temporal data from said accurate timing unit as said RA drive control mechanism rotates said RA drive shaft, wherein said temporal data corresponds to said angular position data;
generating a series of tracking pulses from said angular position data in order to evaluate rotation of said RA drive shaft, wherein said series of tracking pulses is generated by said MCU;
analyzing said series of tracking pulses in order to determine rotation errors for said RA drive shaft, wherein said series of tracking pulses is analyzed by said MCU;
generating correction instructions in order to rectify said rotation errors for said RA drive shaft, wherein said correction instructions is generated by said MCU; and
inputting said correction instructions into said RA drive control mechanism as said RA drive control mechanism rotates said RA drive shaft in order to rotate said RA drive shaft at a desired rotational speed.

4. The method of implementing a system to improve Right-Ascension-rotation accuracy for a telescope of claim 3, wherein:
said pulse order of each reference tracking pulse is counted from said index pulse; and
said actual angular position of each reference tracking pulse is measured from said index pulse.

5. The method of implementing a system to improve Right-Ascension-rotation accuracy for a telescope, the method as claimed in claim 3, wherein said desired rotational speed is an actual sidereal speed of the Earth's rotation.

6. The method of implementing a system to improve Right-Ascension-rotation accuracy for a telescope, the method as claimed in claim 3, wherein said desired rotational speed is an adjusted sidereal speed of the Earth's rotation in order to compensate for atmospheric refraction at a given direction on the celestial sky.

7. The method of implementing a system to improve Right-Ascension-rotation accuracy for a telescope, the method as claimed in claim 3 comprises the steps of:
providing said IQO encoder with an encoder rotor, wherein said encoder rotor comprises a coded track and an index mark;
retrieving said index pulse by reading said index mark off said encoder rotor, wherein said encoder rotor produces said index pulse once every full rotation;
zeroing a counter when said index pulse is received from said IQO encoder, wherein said counter is managed by said microcontroller unit;
retrieving a first pulse channel and a second pulse channel by reading said coded track off said encoder rotor, wherein said first pulse channel and said second pulse channel are phase shifted from each other;
deriving a rotation direction for said RA drive shaft by reading an order between rising/falling edges of said first pulse channel and said second pulse channel;
incrementing a counter for every rising/falling edge from both said first pulse channel and said second pulse channel as said RA drive shaft rotates in a positive direction, wherein said positive direction is defined as with the Earth's rotation;
decrementing said counter for every rising/falling edge from both said first pulse channel and said second pulse channel as said RA drive shaft rotates in a negative direction, wherein said negative direction is defined as against the Earth's rotation;
generating a tracking pulse for each increment on said counter;
retrieving an occurrence time for said tracking pulse from said accurate timer unit; and
retrieving said actual angular position for said tracking pulse by matching a value for said counter to said pulse order of any reference tracking pulse within said calibrated reference data.

8. The method of implementing a system to improve Right-Ascension-rotation accuracy for a telescope, the method as claimed in claim 7 further comprises the step of:
storing said value for said counter on said persistent electronic memory; and
retrieving said value of said counter from said persistent electronic memory when said MCU is powered on.

9. The method of implementing a system to improve Right-Ascension-rotation accuracy for a telescope, the method as claimed in claim 3 comprises the steps of:
providing each of said plurality of tracking pulses with an occurrence time and an actual angular position, wherein said plurality of tracking pulses includes an initial tracking pulse and a subsequent tracking pulse;
calculating a temporal difference between said occurrence time of said initial tracking pulse from said occurrence time of said subsequent tracking pulse;
calculating an expected change in angular position by multiplying said desired rotational speed with said temporal difference;
calculating an actual change in angular position by subtracting said actual angular position of said initial tracking pulse from said actual angular position of said subsequent tracking pulse;
calculating an angular position error by subtracting said actual change in angular position from said expected change in angular position;
calculating a stop time by dividing said angular position error with said desired rotational speed,
if said angular position error is in a positive direction, wherein said positive direction is defined as with the Earth's rotation;
pausing said rotation of RA drive shaft for said stop time in order to rectify said angular position error, wherein said rotation of RA drive shaft is paused by said RA drive control mechanism;
calculating a catch-up time by dividing said angular position error with a guiding speed,
if said angular position error is in a negative direction, wherein said positive direction is defined as against the Earth's rotation,
wherein said guiding speed is greater than said desired rotational speed; and
increasing said rotation of RA drive shaft to said guiding speed for said catch-up time in order to rectify said angular position error, wherein said rotation of RA drive shaft is increased by said RA drive control mechanism.

10. The method of implementing a system to improve Right-Ascension-rotation accuracy for a telescope, the method as claimed in claim 3 comprises the steps of:
providing a subsequent tracking pulse for every arbitrary tracking pulse;
sequentially reading said calibrated reference data from said arbitrary tracking pulse in order to determine said actual angular position for the said subsequent tracking pulse;
deriving an expected occurrence time for said subsequent tracking pulse from both said desired rotational speed and said actual angular position of said subsequent tracking pulse;
instructing said accurate timing unit to report the occurrence of said subsequent tracking pulse;
generating said correction instructions for said RA drive control mechanism in order to stop said rotation for said RA drive shaft,
if said subsequent tracking pulse is reported by said accurate timing unit prior to said expected occurrence time;
resuming said rotation for said RA drive shaft when said accurate timing unit reports said expected occurrence time of said subsequent tracking pulse;
generating said correction instructions for said RA drive control mechanism in order to rotate said RA drive shaft faster,
if said subsequent tracking pulse is not reported by said accurate timing unit at said expected occurrence time; and
instructing said RA drive control mechanism to maintain said rotation for said RA drive shaft,
if said subsequent tracking pulse is reported by the accurate timing unit at said expected occurrence time.

11. A method of calibrating a system to improve Right-Ascension-rotation accuracy for a telescope, the method comprises the steps of:
providing a telescope with an optical system and an imaging device;
providing a telescope mount, an incremental quadrature optical (IQO) encoder, a microcontroller unit (MCU), an accurate timing unit, a persistent electronic memory, and a control interface;
wherein said telescope mount comprises a Right Accession (RA) drive system;
wherein said IQO encoder comprises an encoder rotor;
wherein said RA drive system comprises an RA drive shaft and an RA drive control mechanism;
positioning said telescope at a polar alignment, wherein said polar alignment occurs when a rotation axis for said telescope mount is parallel to the Earth's rotation axis;
positioning said telescope mount as an equatorial mount;
positioning said imaging device at the focal plane of said optical system;
selecting a reference star in order to generate said calibrated reference data for said IQO encoder, wherein said calibrated reference data includes a pulse order and an actual angular position for each reference tracking pulse;
implementing said imaging device while not rotating said RA drive shaft in order to determine an image speed for said first reference star;
implementing said imaging device while rotating said RA drive shaft in order to determine linear image deviation of said reference star for each reference tracking pulse;
implementing said image speed and said linear image deviation for each reference tracking pulse in order to derive an angular correction for each reference tracking pulse, wherein said angular correction is derived by said MCU;
generating said calibrated reference data in order to account for said angular correction for each reference tracking pulse;
selecting another reference star near a desired direction on the celestial sky in order to determine a visible speed of the Earth's rotation at said desired direction;
measuring an angular change for said other reference star across the celestial sky and clocking a time interval for said angular change in order to calculate said visible speed;
recording a set of visible speeds of the Earth's rotation for multiple desired directions on the celestial sky; and
automatically adjusting rotation of said RA drive shaft from atmospheric refraction by selecting from said set of visible speeds of the Earth's rotation.

12. The method of calibrating a system to improve Right-Ascension-rotation accuracy for a telescope, the method as claimed in claim 11 comprises the steps of:
selecting said reference star near the celestial equator and meridian;
registering said reference star on the imaging device through said telescope;
taking a first series of short exposures for said reference star with said imaging device as said RA drive control mechanism stops rotation of said RA drive shaft, wherein each of said first series of short exposures includes an capture time and a linear position of said reference star;
determining said image speed for said reference star by implementing a least square fit with said capture time and said linear position for each of said first series of short exposures,
converting said image speed into angular units by using Earth's sidereal speed of rotation and said capture time;
initiating rotation of said RA drive shaft with said RA drive control mechanism at a tracking speed, wherein said tracking speed is expected to be equal to the Earth's sidereal speed of rotation;
taking a second series of short exposures for said reference star with said imaging device as said RA drive control mechanism rotates said RA drive shaft at said tracking speed, wherein each of said second series of short exposures includes a capture time;
wherein said second series of short exposures includes an initial exposure and subsequent exposures;
calculating an angular position for each of said second series of exposures from both said capture time and the Earth's sidereal speed of rotation, wherein said angular position corresponds to said rotation of said RA drive shaft;
deriving a linear positional deviation of said reference star for each subsequent exposure from an original position in said initial exposure,
calculating an angular correction from both said linear positional deviation and said image speed in angular units;
calculating a corrected angular position for said RA drive shaft by adding said angular correction to said angular position from each of said second series of exposures;
retrieving a pulse order for each reference tracking pulse from said IQO encoder;
retrieving an occurrence time for each reference tracking pulse from said accurate timing unit; and
calculating said actual angular position for each reference tracking pulse by interpolating said corrected angular position from a nearest exposure time within said second set of short exposures.

13. The method of calibrating a system to improve Right-Ascension-rotation accuracy for a telescope, the method as claimed in claim 11 comprises the steps of:
providing a high accuracy positional encoder, wherein said high accuracy positional encoder has a high resolution;
coaxially and mechanically attaching said high accuracy positional encoder to said RA drive shaft;
electronically connecting said high accuracy positional encoder to said MCU;
pointing said telescope in said desired direction and selecting said other reference star in view of said telescope;
centering said telescope on said other reference star at a first position in the celestial sky;
retrieving a first angular position for said first position in the celestial sky from said high accuracy positional encoder;
clocking a first time for said first position in the celestial sky with said accurate timing unit;
re-centering said telescope on said other reference star at a second position in the celestial sky, wherein a general orientation of said telescope with respect to said desired direction does not change between said first position and said second position of said other reference star;
retrieving a second angular position for said second position in the celestial sky from said high accuracy positional encoder;
clocking a second time for said second position in the celestial sky with said accurate timing unit;
calculating said angular change by subtracting said first angular position from said second angular position;
calculating said time interval by subtracting said first time from said second time, wherein said time interval is selected to be close or greater to a desired duration of imaging exposure; and
calculating said visible speed of the Earth's rotation by dividing said angular change with said time interval.

14. The method of calibrating a system to improve Right-Ascension-rotation accuracy for a telescope, the method as claimed in claim 13 comprises the steps of:
retrieving a plurality of desired directions through said control interface;
calculating said visible speed of the Earth's rotation for each of the plurality of desired directions;
retrieving a specific angular position for said RA drive shaft from said IQO encoder;
storing said visible speed with said specific angular position for each of said plurality of desired directions within said persistent electronic memory;
building a mathematical model from said visible speed and said specific angular position for each of said plurality of desired directions, wherein said mathematical model describes the Earth's atmospheric refraction; and
referencing said mathematical model in order to determine a correct rotational speed for said RA drive shaft in a given direction.
